(19) United States
(12) Patent Application Publication
(10) Pub. No.: US 2007/0300010 A1
(43) Pub. Date: Dec. 27, 2007

(54) APPARATUS FOR FAST ACCESSES TO FLASH MEMORY

(75) Inventors: Cheng-chih Yang, Taipei City (TW); Fong-hsu Wei, Shenkeng Township (TW); Che-wei Chang, Chiayi City (TW)

Correspondence Address: MADSON & AUSTIN, 15 WEST SOUTH TEMPLE, SUITE 900, SALT LAKE CITY, UT, 84101, US

(73) Assignee: Genesys Logic, Inc., Shindian City (TW)

(21) Appl. No.: 11/764,920

(22) Filed: Jun. 19, 2007

(30) Foreign Application Priority Data
Jun. 23, 2006 (TW) 095210986

(51) Int. Cl. G06F 12/00

(52) U.S. Cl. 711/103

(57) ABSTRACT

An apparatus for fast access to flash memory is provided, including a flash memory and an access controller. A system data reserved region is configured in the flash memory to provide temporary storage for data and instruction used in the flash memory access. The access controller includes a flash memory control interface, a RAM, a RAM DMA unit, and an ECC unit. The flash memory control interface is connected to the flash memory. The DMA unit and the ECC unit are connected between the RAM and the flash memory control interface to provide direct access and error correction functions, as well as allowing, during the data access to the flash memory, the data and the system instruction of the system data reserved region in the flash memory to go through the flash memory control interface, the DMA unit and the ECC unit to load into the RAM for acting as an extended memory for the RAM to effect fast access to the flash memory and extending the RAM capacity.

### BACKGROUND OF THE INVENTION

1. Field of the Invention

The present invention relates to an apparatus for fast accesses to flash memory and, more particularly, to an apparatus with cache configuration and random memory access capacity extension for fast accesses to flash memory data.

2. The Related Arts

Flash memory is widely used in many digital equipments, such as digital cameras, TV game boxes, and flash drives. Conventionally, data accesses to flash memory require the control of a data access control circuit. FIG. 1 of the attached drawings shows a conventional flash memory data access control circuit A, including a flash memory control interface A1, a random access memory (RAM) A2, a microprocessor A3, a direct memory access (DMA) unit A4, and an upstream interface A5. The flash memory control interface A1 is connected to a flash memory B for controlling data access to the flash memory B. The RAM A2 is connected to the flash memory control interface A1 for providing data and instruction storage required in data access to the flash memory B. The microprocessor A3 is the core for controlling flash memory. The DMA unit A4 provides direct memory access required in data access to the flash memory B. The upstream interface A5 provides connections to an electronic device, such as a personal computer and a notebook computer, so that the electronic device can be connected to the flash memory B for data access.

In the above-discussed conventional control circuit A, because the data and the instruction required for data access to the flash memory B are stored in the RAM A2, the capacity of the RAM A2 is proportional to the capacity of the flash memory B. In other words, the larger the flash memory B is, the larger the RAM A2 is required. The implication is that a different-sized flash memory B will require a different control circuit A with a different-sized RAM A2. This is a major inconvenience for data access control for flash memory.

In addition, during the data access, the RAM A2 of the conventional control circuit A must follow the path through the microprocessor A3 and the DMA unit A4 before accessing flash memory. This imposes a further time delay on data access.

Taiwan Patent No. 250404 disclosed a method for using flash memory as the buffer of electronic devices. The feature of the disclosed method includes that the memory region is configured in the flash memory to replace the RAM when the microprocessor issues an instruction. However, there is no direct access and error correction during transmitting the instruction. This may lead to delay in data transmission delay and increase in data error rate.

### SUMMARY OF THE INVENTION

The primary object of the present invention is to provide an apparatus for fast access to flash memory, including the configuration of at least a system data reserved region in the flash memory to act as the extended memory for the RAM in the data access controller to provide the temporary storage and fast access for the data and instruction used during flash memory data access.

Another object of the present invention is to provide an apparatus for fast access to flash memory, including a DMA unit for RAM and an error correction code (ECC) unit between the RAM and the flash memory control interface of the data access controller to provide the functions of fast direct access and the error correction to the data and instruction transmission between the RAM and the system data reserved region in the flash memory.

Yet another object of the present invention is to provide an apparatus for fast access to flash memory so that the data access to flash memory and system instruction can be transmitted from RAM through DMA unit, ECC unit, and flash memory control interface to the system data reserved region in the flash memory, or vice versa in the reverse transmission direction, to shorten the data transmission path and time.

To achieve the above objects, the present invention provides an apparatus for fast access to flash memory, including a flash memory and an access controller. A system data reserved region is configured in the flash memory to provide temporary storage for data and instruction used in flash memory access. The access controller includes a flash memory control interface, a RAM, a RAM DMA unit, and an ECC unit. The flash memory control interface is connected to the flash memory. The DMA unit and the ECC unit are connected between the RAM and the flash memory control interface to provide direct access and error correction functions, as well as allowing, during the data access to the flash memory, the data and the system instruction of the system data reserved region in the flash memory to go through flash memory control interface, DMA unit and ECC unit to load into RAM for acting as an extended memory for the RAM to achieve the objects of fast access to flash memory can extending the RAM capacity.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 shows a block diagram of a conventional flash memory data access control circuit;

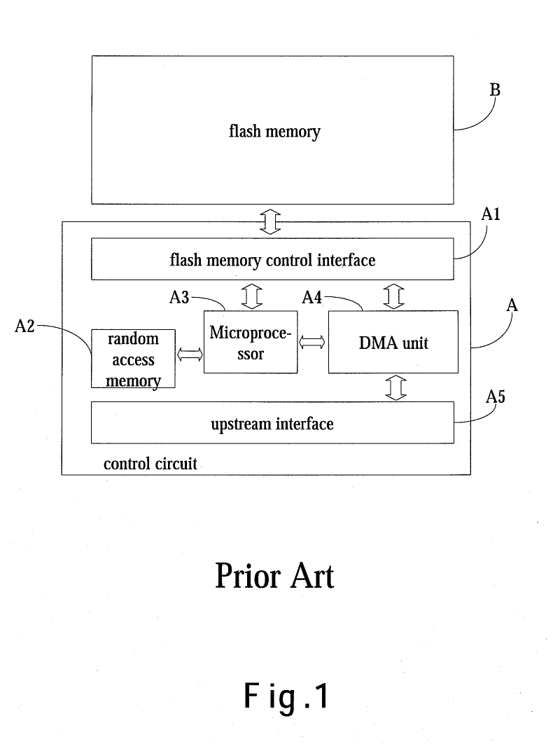

FIG. 2 shows a block diagram of a fast data access apparatus of the present invention; and

FIG. 3 shows a flowchart of a fast data access apparatus of the present invention.

### DETAILED DESCRIPTION OF THE PREFERRED EMBODIMENT

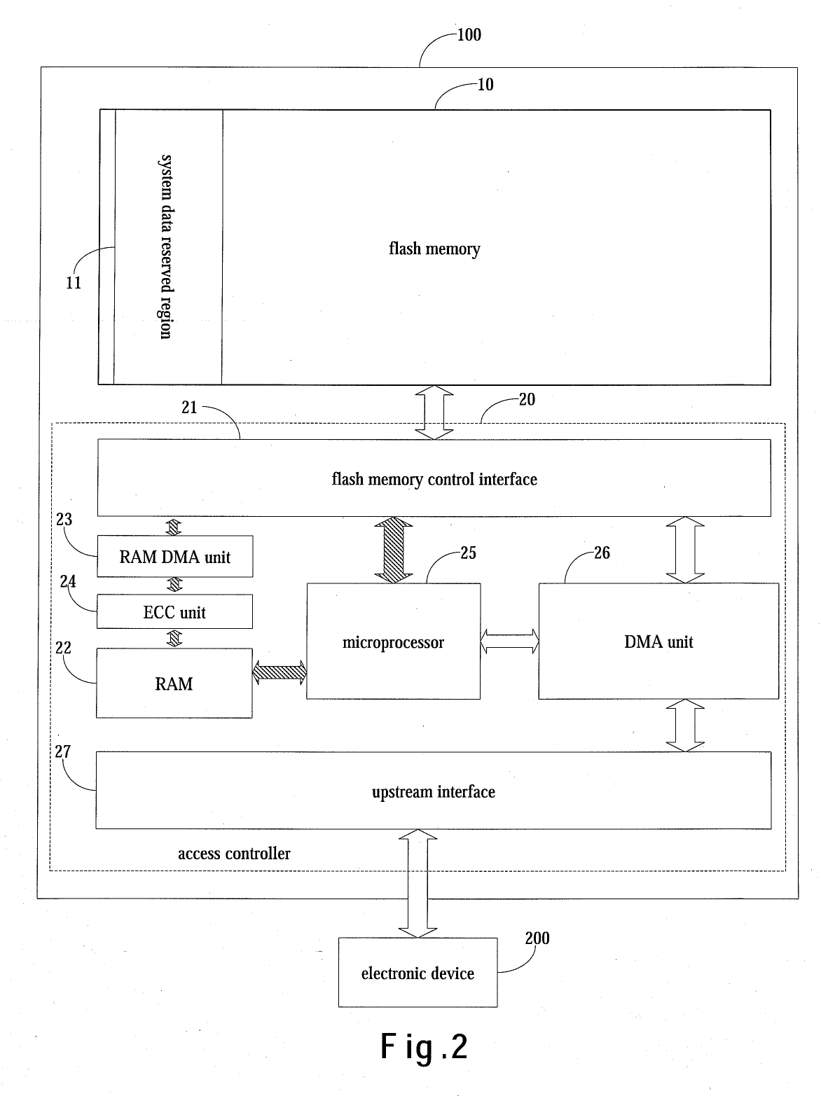

With reference to the drawings and in particular to FIG. 2, a block diagram of an apparatus 100 of fast data access to flash memory comprises a flash memory 10 and an access controller 20. A system data reserved region 11 is configured in the flash memory 10. The system data reserved region 11 is not limited to any configuration method. The present embodiment configures the region during formatting the flash memory 10. The system data reserved region 11 is for the temporary storage of data and system instruction during the data access.

The access controller 20 further includes a flash memory control interface 21, a RAM 22, a RAM DMA unit 23, an ECC unit 24, a microprocessor 25, a DMA unit 26 and an upstream interface 27. The flash memory control interface 21 is connected to the flash memory 10 to provide interface between the flash memory 10 and the access controller 20. The RAM 22 provides temporary storage for data and system instruction for the flash memory 10 data access.

The RAM DMA unit 23 and the ECC unit 24 are connected between the RAM 22 and the flash memory control interface 21. The RAM DMA unit 23 is connected to the flash memory control interface 21 and the ECC unit 24 to provide direct access to the data and the instruction stored in the flash memory 10. The ECC unit 24 is connected to the RAM DMA unit 23 and the RAM 22 to provide error correction of data and system instruction of the flash memory 10.

The RAM DMA unit 23 and the ECC unit 24 can also be integrated into a single circuit or an IC.

The microprocessor 25 is connected to the flash memory control interface 21 and the RAM 22. The RAM 22 provides access to data and system instruction to the microprocessor 25 so that the microprocessor 25 can provide access control to the flash memory 10.

The DMA unit 26 is connected between the flash memory control interface 21 and the microprocessor 25 to provide the microprocessor 25 with direct access to the flash memory 10.

The upstream interface 27 is connected to the DMA unit 26 and an electronic device 200. The upstream interface 27 is not limited to any specific type. The present embodiment uses a USB interface for providing external electronic device data access to the flash memory. Other interfaces, such as SATA or PCI_E are also within the scope of the present invention. The electronic device 200 is any electronic device with a USB interface, such as a personal computer, a notebook computer, a PDA, and a mobile phone.

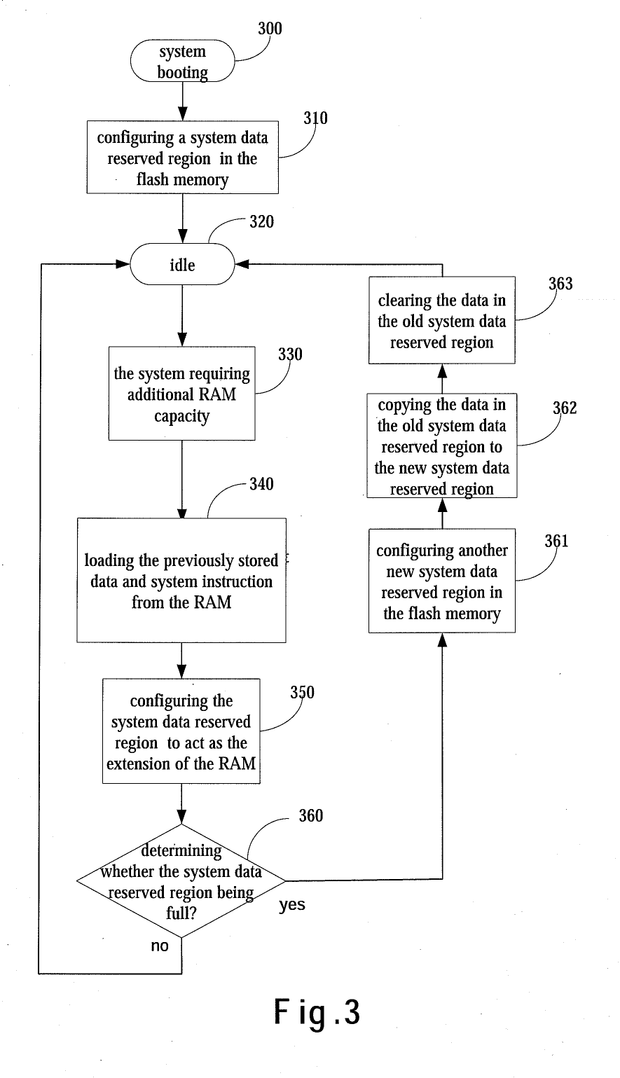

FIG. 3 shows a flowchart of the operation of the apparatus 100 for fast access to flash memory in accordance with the present invention. The flowchart includes the following steps:

(300) system booting;

(310) configuring a system data reserved region 11 in the flash memory 10;

(320) the system data reserved region staying idle so that the flash memory 10 can access data and system instruction at any time;

(330) the system requiring additional RAM capacity, when the capacity of the RAM 22 of the access controller 20 is insufficient;

(340) loading the previously stored data and system instruction from the RAM 22 to the system data reserved region 11 through the RAM DMA unit 23 and the ECC unit 24;

(350) configuring the system data reserved region 11 to act as the extension of the RAM 22;

(360) determining whether the system data reserved region being full? if so, proceeding to step 361; otherwise, returning to step 320;

(361) configuring another new system data reserved region 11 in the flash memory 10;

(362) copying the data in the old system data reserved region to the new system data reserved region created in step 361; and

(363) clearing the data in the old system data reserved region to make room for temporary storage for data and instruction for the next time, and returning to step 320.

Through the above steps, the apparatus 100 of the present invention can configure a system data reserved region of any capacity in the flash memory 10 to provide extended memory for the RAM 22 in the access controller 20 without the need to modify the RAM 22 or its capacity inside the access controller 20. Further more, the RAM DMA unit 23 and the ECC unit 24 provide direct access and error correction functions so as to speed up the data access to the flash memory 10.

While the invention has been described in connection with what is presently considered to the most practical and preferred embodiment, it is to be understood that the invention is not to be limited to the disclosed embodiment, but on the contrary, is intended to cover various modifications and equivalent arrangement included within the spirit and scope of the appended claims.

What is claimed is:

1. An apparatus for fast access to flash memory, comprising:
a flash memory, configured with a system data reserved region for providing temporary storage to data and system instruction for flash memory data access; and
an access controller, comprising a flash memory control interface, a RAM, a RAM DMA unit, an ECC unit, a microprocessor, a DMA unit and an upstream interface, the flash memory control interface being connected to the flash memory to provide access interface to the flash memory, the RAM providing temporary storage for data and system instruction for data access to the flash memory, the RAM DMA unit being connected to the flash memory control interface to provide direct access to the data and the instruction stored in the flash memory, the ECC unit being connected to the RAM DMA unit and the RAM to provide error correction of data and system instruction of the flash memory and allow the data and the system instruction of the RAM to go through the RAM DMA unit, the ECC unit, and the flash memory control interface to load into the system data reserved region in the flash memory, the microprocessor being connected to the flash memory control interface and the RAM for providing access control to the flash memory, the DMA unit being connected between the flash memory control interface and the microprocessor to provide direct access to the flash memory, and the upstream interface being connected to the DMA unit and an electronic device.

2. The apparatus as claimed in claim 1, wherein the RAM DMA unit and the ECC unit are integrated into a single IC.

3. The apparatus as claimed in claim 1, wherein the upstream interface of the access controller is a USB interface.

4. The apparatus as claimed in claim 1, wherein the electronic device connected to the upstream interface is an electronic device with a USB interface.

5. The apparatus as claimed in claim 1, wherein the upstream interface of the access controller is a SATA interface.

6. The apparatus as claimed in claim 1, wherein the upstream interface of the access controller is a PCI_E interface.
